(19) United States
(12) Patent Application Publication
(10) Pub. No.: US 2025/0354749 A1
(43) Pub. Date: Nov. 20, 2025

(54) REFRIGERATOR

(71) Applicant: LG Electronics Inc., Seoul (KR)

(72) Inventors: Seongun KIM, Seoul (KR); Jaewoong KIM, Seoul (KR); Seongjun YUN, Seoul (KR); Jimin LEE, Seoul (KR); Hong Seung DO, Seoul (KR); Kyongho JUNG, Seoul (KR)

(73) Assignee: LG Electronics Inc., Seoul (KR)

(21) Appl. No.: 19/212,215

(22) Filed: May 19, 2025

(30) Foreign Application Priority Data
May 20, 2024 (KR) 10-2024-0065412

(51) Int. Cl. F25D 25/02; F25D 27/00

(52) U.S. Cl. CPC F25D 25/02; F25D 27/00; F25D 2325/022

(57) ABSTRACT

A refrigerator according to the present invention has a configuration in which a plurality of pattern portions are disposed on the lower surface of the plate of the shelf so as to have predetermined intervals therebetween, thereby capable of causing the diffuse reflection by the pattern portions to the light irradiated to the rear surface of the plate.

### CROSS-REFERENCE TO RELATED APPLICATION

This application claims priority to and the benefit of Korean Patent Application No. 10-2024-0065412, filed on 2024 May 20, the disclosure of which is incorporated herein by reference in its entirety.

### BACKGROUND

### Field

The present invention relates to a refrigerator.

### Description of Related Art

A refrigerator is a home appliance that supplies cold air generated by utilizing the circulation of refrigerant to a storage chamber, thereby keeping various types of storage objects fresh for a long period of time.

To more easily identify the articles of food stored in the storage chamber, a lighting device may be provided in the storage chamber.

The lighting device may be disposed on the wall in the rear side or left and right sides of the storage chamber to illuminate the inside of the storage chamber when the door is opened.

However, in the case of the lighting device disposed on the wall of the storage chamber, users may be directly exposed to light, and so if the illuminance is high, glare may occur to the users.

Additionally, in the case of lowering the illuminance of the lighting device to alleviate the glare problem, there is a problem of not sufficiently illuminating the inside of the storage chamber.

Besides, in the case where articles of food are positioned adjacent to a place from which the lighting device illuminates, they block the lighting device, and so there is a problem in that the entire space of the storage chamber is not evenly illuminated by the light.

Meanwhile, for the purpose of efficient storage of articles of food and user's usage convenience, a shelf may be provided inside the storage chamber.

Generally, the shelf is formed to have a very great support surface area in the horizontal direction across the storage chamber, so that it can sufficiently support a great number of articles of food.

If the shelf with a great surface area for supporting articles of food could be used as a lighting, it would be possible to improve the availability of the inner space of the refrigerator and evenly distribute light throughout the inside of the refrigerator.

For example, to use the shelf as a lighting, light of a lighting device may be irradiated to the side surface of the shelf.

However, if most of the light irradiated to one side surface of the shelf undergoes total reflection inside the shelf, the light is not emitted through the shelfs support surface with the great surface area, and most of the light is emitted through the other side surface of the shelf.

Consequently, in order to evenly distribute light throughout the inside of the refrigerator, it is necessary to reduce the proportion of light undergoing the total reflection inside the shelf so that as much light as possible is emitted through the surface of the shelf, which support the articles of food.

### SUMMARY

It is an object of the present invention to provide a refrigerator including a shelf substantially functioning as a lighting device.

Also, it is an object of the present invention to provide a refrigerator in which the inside of a storage chamber can be evenly and effectively illuminated without being affected by the locations of the articles of food.

Also, it is an object of the present invention to provide a refrigerator in which the top surface of the shelf can emit light as much as possible.

Also, it is an object of the present invention to provide a refrigerator in which dark regions are reduced on the top surface of the shelf.

Also, it is an object of the present invention to provide a refrigerator in which the light uniformity is improved regardless of the disposition position of a lighting device.

Also, it is an object of the present invention to provide a refrigerator in which the problem of glare in user's eyes due to a lighting device can be relieved.

Also, it is an object of the present invention to provide a refrigerator in which it is possible to prevent the occurrence of a short circuit between a light-emitting member and a frame storing the light-emitting member.

The purposes of the present invention are not limited to the purposes mentioned above, and other purposes and advantages of the present invention which are not mentioned can be appreciated from the following description, and will be more clearly appreciated by the embodiments of the present invention. Furthermore, it is readily understood that the objects and advantages of the present invention can be achieved by the means set forth in the claims and combinations thereof.

A refrigerator according to an embodiment of the present invention for accomplishing the above-described object comprises a cabinet including at least one storage chamber, and at least one shelf disposed within the storage chamber.

In this case, the shelf includes a plate, and a first lighting device disposed at a rear side of the plate and irradiating light to a rear surface of the plate, and a plurality of pattern portions are disposed on a lower surface of the plate at predetermined intervals.

The plate and the pattern portions may be composed of materials having different refractive indices.

The plate may be composed of glass material.

The pattern portions may be an embossed pattern protruding downward from the lower surface of the plate.

The pattern portions may be an engraved pattern recessed into the lower surface of the plate.

The plurality of pattern portions may be arranged in a front-rear direction of the plate, and the intervals between the plurality of pattern portions may be constant.

The plurality of pattern portions may be arranged in a front-rear direction of the plate, and the intervals between the plurality of pattern portions may be different from each other.

The plurality of pattern portions may be arranged in a front-rear direction of the plate, and the intervals between the plurality of pattern portions may be decreased with increasing distance from the first lighting device.

The intervals between the plurality of pattern portions may be decreased by a constant amount relative to the adjacent preceding interval.

The pattern portions may be a linear pattern extending along a left-right direction of the plate.

The pattern portion may be extend continuously along the left-right direction of the plate.

The first lighting device may include a first light-emitting member comprising one or more light sources disposed along the rear surface of the plate, and opposite side ends of the pattern portion may protrude further outwards than outer ends of the outermost light sources, respectively.

The shelf may further include a reflective member extending along a front surface of the plate to be disposed on the front surface of the plate.

The first lighting device may include a first light-emitting member including a substrate extending in one direction and one or more light sources disposed on the substrate, and a first cover member storing the first light-emitting member, and the first cover member may surround an entire surface of the first light-emitting member except at least one of its opposite sides.

The shelf may further include a rear frame storing the first cover member and finishing the rear surface of the plate, and the first cover member may be composed of an insulating material, and the rear frame may include a metal material.

The first cover member may be a diffusion member diffusing light emitted from the first light-emitting member.

A front surface of the first cover member may be positioned between the first light-emitting member and the rear surface of the plate, and the first light-emitting member, the front surface of the first cover member, and the plate may be positioned to overlap with each other in a front-rear direction.

The shelf may further include a second lighting device disposed at a front side of the plate and irradiating light to a front surface of the plate, and the plurality of pattern portions may be arranged in a front-rear direction of the plate, and the intervals between the plurality of pattern portions may be constant.

An interval between the front surface of the plate or the rear surface of the plate and an outermost pattern portion may be greater than an interval between pattern portions adjacent to each other.

A surface area of a pattern region on the lower surface of the plate, in which the pattern portions are disposed, may be greater than a surface area of a non-pattern region on the lower surface of the plate, in which no pattern portion is disposed.

On a side surface of the storage chamber one or more power supply parts are disposed which transmit power wirelessly, and the shelf may further include a pair of side frames finishing opposite side surfaces of the plate, and on the side frame a power receiver may be disposed which receives power transmitted from the power supply part and transmits it to the first lighting device.

In a rear side of the storage chamber, one or more shelf mounting members may be disposed, each including a plurality of mounting holes to which the shelf is mounted, and extending in an up-down direction, and the power supply part may be provided in a plural number, and the plurality of power supply parts may be arranged in an up-down direction along a direction in which the shelf mounting member extends.

Each of the power supply parts may be disposed correspondingly parallel to each of the mounting holes.

A refrigerator according to the present invention has a configuration in which a plurality of pattern portions are disposed on the lower surface of the plate of the shelf so as to have predetermined intervals therebetween, thereby capable of facilitating diffuse reflection by the pattern portions to the light irradiated to the rear surface of the plate.

Consequently, most of the light can be guided to be emitted through the top surface of the shelf with a great surface area, so that the shelf can function as a shelf lighting which distributes light as evenly as possible.

Additionally, the refrigerator according to the present invention has an configuration which enhances diffuse reflection efficiency in the pattern portion due to the fact that the plate and the pattern portion disposed on the lower surface of the plate are composed of materials having different refractive indices.

Additionally, the refrigerator according to the present invention can implement shelf lighting with reduced dark regions on the top surface of the plate by disposing the lighting device on the rear surface of the plate and formed a plurality of pattern portions spaced apart from each other in the front-rear direction on the lower surface of the plate.

Additionally, the refrigerator according to the present invention can implement shelf lighting with improved illumination uniformity as well as reduced dark regions even on the top surface of the plate far from the lighting device by reducing the interval between pattern portions adjacent to each other as the distance from the lighting device increases from the lighting device.

Additionally, the refrigerator according to the present invention can evenly and effectively illuminate the inside of the storage chamber without being affected by the locations of articles of food even when a large number of food items are stored in the storage chamber, since the plate having a large support surface area can diffuse the light of the lighting device.

Additionally, the refrigerator according to the present invention can prevent the problem of glare of a user since most of light is emitted through the top surface of the plate, preventing direct exposure of the user to the light.

Additionally, in the case where the light-emitting member is stored in the frame, the refrigerator according to the present invention can prevent the occurrence of a short circuit between the frame and the light-emitting member, and thus improve the reliability of the light-emitting member, by configuring the light-emitting member to be encased by a cover member that encloses the entire surface except for the side into which the light-emitting member is inserted, so that direct contact between the frame and the light-emitting member can be prevented.

In addition to the effects described above, specific effects of the present invention will be described below together with specific matters for practicing the invention.

### BRIEF DESCRIPTION OF DRAWINGS

FIG. 1 is a front view of a refrigerator with a door open.

FIG. 2 is a perspective view of a shelf according to one embodiment.

FIG. 3 illustrates a power supply part and a shelf mounting member for securing a shelf according to one embodiment.

FIG. 4 is an exploded perspective view of a shelf according to one embodiment.

FIG. 5 is an exploded perspective view of a shelf according to another embodiment.

FIG. 6 is a side view of a rear frame finishing the rear surface of a plate and a first lighting device stored in the rear frame, according to one embodiment.

FIG. 7 is a side view illustrating light refracted by a pattern portion formed on the lower surface of a plate according to one embodiment.

FIG. 8 illustrates angles at which light is refracted or reflected at the interface.

FIG. 9 is a side view illustrating light refracted by a pattern portion formed on the lower surface of a plate according to another embodiment.

FIGS. 10 to 14 illustrate the lower surface of a plate, which has a pattern portion formed thereon, and a lighting device irradiating light to the plate, according to various embodiments.

### DETAILED DESCRIPTIONS

The purposes, features and advantages described above will be described in detail below with reference to the accompanying drawings, so that a person having ordinary knowledge in the technical field to which the present invention pertains can easily practice the technical idea of the present invention. In describing the present invention, if it is determined that a detailed description of a known technology related to the present invention may unnecessarily obscure the gist of the present invention, the detailed description thereof will be omitted. Hereinafter, preferred embodiments of the present invention will be described in detail with reference to the accompanying drawings. In the drawings, like reference symbols are used to refer to like or similar components.

Although the terms “first”, “second”, and so on are used to describe various components, these components are not limited by these terms. These terms are merely used to distinguish one component from another component, and unless specifically stated to the contrary, it should be understood that a first component may also be a second component.

Throughout the specification, unless specifically stated to the contrary, each element may be singular or plural.

Hereinafter, the phrase “any configuration is disposed in the upper side of (or in the lower side of) a component” or “on (or below) a component” may mean not only that any configuration is disposed in contact with the top surface (or lower surface) of said component, but also that another configuration may be interposed between said component and any configuration disposed on (or below) said component.

Additionally, when a component is described as being “connected,” “coupled,” or “contacted” to another component, it should be understood that although the both components may be directly connected, coupled or contacted to each other, a third component may also be “interposed” between the both components, or the both components may be “connected,” “coupled,” or “contacted” to each other through a third component.

As used herein, singular expressions include plural expressions unless the context clearly dictates otherwise. Herein, the terms “be comprised of” or “comprise” should not be construed to necessarily include all of the various components or various steps described in the specification, and should be construed to mean that some of the components or some of the steps may not be included, or that additional components or steps may be included.

Throughout the disclosure, the phrase “A and/or B” means A, B, or A and B, unless otherwise specified, and the phrase “C to D” means equal to or greater than C and equal to or smaller than D unless otherwise specified.

Hereinafter, a refrigerator according to some embodiments of the present invention will be described.

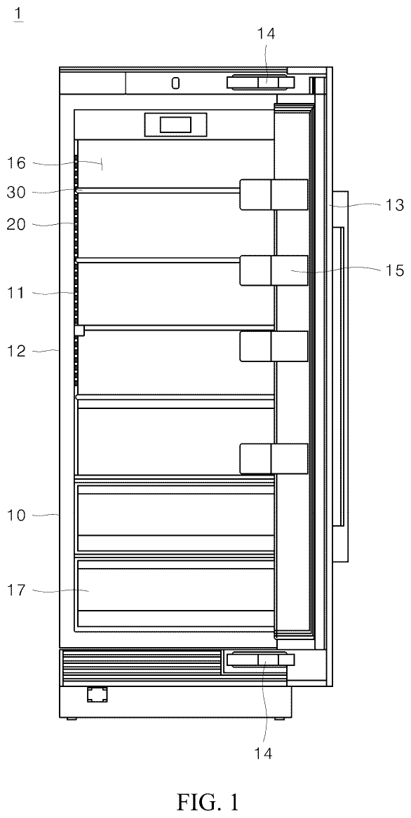

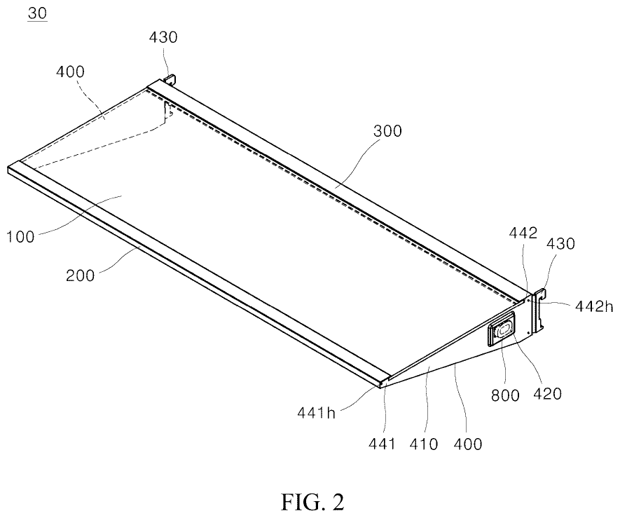

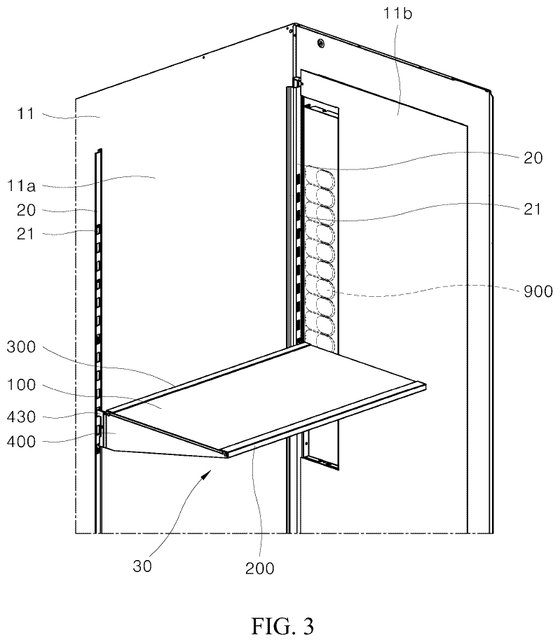

A refrigerator including a shelf according to one embodiment of the present invention will be described with reference to FIGS. 1 to 3.

A refrigerator 1 may have an exterior formed by a cabinet 10 with one or more storage chambers 16 therein as storage spaces for products, and by one or more doors 13 configured to open and close the open front side of the cabinet 10.

The cabinet 10 may include an outer case 12 and an inner case 11 coupled to the inside of the outer case 12.

The inner case 11 may include at least one storage chamber 16, and the storage chamber 16 may be a cooling chamber or a freezing chamber.

Although the inner case 11 is illustrated as including one storage chamber 16 In FIG. 1, the embodiments are not limited to this, and the inner case 11 may be partitioned to have a plurality of storage chambers.

The door 13 may be a rotary door configured to be rotated around a pair of hinges 14 positioned at the top and bottom, respectively; however, the embodiments are not limited to this.

In the case where there are a plurality of storage chambers, there may be also a plurality of doors so that each storage chamber can be opened and closed.

Meanwhile, in the door 13 one or more storage parts 15 may be disposed which are capable of storing and supporting articles of food.

Additionally, within the storage chamber 16 one or more drawers 17 and shelves 30 may be disposed which are capable of storing and supporting articles of food.

For example, in the lower region of the storage chamber 16 one or more drawers 17 may be disposed.

The drawer 17 may provide a drawer-type storage space which can be pulled out and inserted back in the front-rear direction.

In the upper side of the drawer 17 one or more shelves 30 may be disposed.

In the case where a plurality of shelves 30 are provided, the adjacent shelves 30 may be disposed to be spaced apart from each other in a vertical direction by a predetermined distance.

Additionally, FIG. 1 illustrates, by way of example, that one shelf 30 is disposed at the same height; however, the embodiments are not limited to this.

For example, a plurality of shelves 30 may be disposed parallel to each other at the same height.

In this case, within the storage chamber 16, a plurality of shelves 30 may be disposed parallel to each other in the left-right direction, and a plurality of shelves 30 may be disposed parallel to each other in the up-down direction.

The shelf 30 may include a plate 100 having a large surface area for supporting articles of food, a front frame 200 which finishes the front surface of the plate 100, a rear frame 300 which finishes the rear surface of the plate 100, and a pair of side frames 400 which finish opposite side surfaces of the plate 100.

For example, at least a portion of the front end of the shelf 30 may be inserted and fixed into the front frame 200, and at least a portion of the rear end of the shelf 30 may be inserted and fixed into the rear frame 300.

And at least a portion of the side end of the shelf 30 may be disposed on the side frame 400, so that its lower surface can be supported by the side frame 400.

The side frame 400 may include a front shield 441 and a rear shield 442 which finish the open sides of the front frame 200 and the rear frame 300, respectively.

In the front shield 441 a front fastening hole 441h may be formed so that the front frame 200 and the side frame 400 can be fastened to each other by a separate fastening member such as a screw.

Additionally, in the rear shield 442 a rear fastening hole 442h may be formed so that the rear frame 300 and the side frame 400 can be fastened to each other by a separate fastening member such as a screw.

At the rear end of the side frame 400 a mounting protrusion 430 may be formed.

For example, the mounting protrusion 430 may be formed in a hook shape, such as a shape that protrudes rearward from the rear end of the side frame 400 and then bends downward.

The shelf 30 may be detachably mounted in the storage chamber 16.

Additionally, the mounting height of the shelf 30 may be freely adjusted by removing and mounting the shelf 30.

The shelf 30 may be configured so that its rear end is mounted on the rear wall of the storage chamber 16 in a cantilever manner.

In the rear side of the storage chamber 16 a shelf mounting member 20 may be disposed, to which the shelf 30 can be mounted and fixed.

For example, the shelf mounting member 20 may be mounted on the rear surface 11a of the inner case 11.

The shelf mounting member 20 may be disposed to extend along the rear wall in the up-down direction of the storage chamber 16.

For example, the shelf mounting members 20 may be provided in a pair, and the pair of shelf mounting members 20 may be disposed to be fixed on the rear wall while being spaced apart from each other in the left-right direction.

Each shelf mounting member 20 may have one or more mounting holes 21 formed therein, to which the mounting protrusion 430 formed at the rear end of the shelf 30 can be inserted and fastened.

The mounting hole 21 may be formed in a form in which the front side is open so that the mounting protrusion 430 can be inserted.

The mounting holes 21 may be provided in a plural number, and may be arranged so as to be spaced apart from each other in the up-down direction along the direction in which the shelf mounting member 20 extends.

The pair of shelf mounting members 20 may be disposed at positions corresponding to the mounting protrusions 430 formed at the rear end of each shelf 30.

For example, the pair of shelf mounting members 20 may be disposed to be spaced apart from each other in the left-right direction by the same interval as the pair of mounting protrusions 430.

Thereby, the user can freely adjust the mounting height of the shelf 30 by removing the mounted shelf 30 and then fastening the mounting protrusions 430 of the shelf 30 to the mounting holes 21 at the desired height.

Additionally, when a plurality of shelves 30 are disposed parallel to each other at the same height, a plurality of shelf mounting members 20 may be arranged correspondingly parallel to each other in the left-right direction.

For example, a pair of shelf mounting members 20 may be disposed on the left and right sides of the rear of the storage chamber 16, respectively, and an additional shelf mounting member 20 may be disposed in the central region of the rear of the storage chamber 16.

In this case, the shelf mounting member 20 disposed in the central region may also be disposed in a plural number, and, however, when one shelf mounting member 20 is disposed in the central region, a pair of shelves 30 disposed parallel to each other at the same height may share the shelf mounting member 20 disposed in the central region.

Meanwhile, on the shelf 30 at least one lighting device 500, 600 may be disposed.

On the side frame 400 a power receiver 800 may be disposed, which supplies power to the lighting device.

The power receiver 800 may be disposed in only one side frame 400 among the pair of side frames 400.

In the case where a plurality of shelves 30 are arranged at the same height, each shelf 30 may have a power receiver 800 disposed on an opposite side frame 400.

That is, a power receiver 800 may be placed on the side frame 400 of each shelf 30, which is adjacent to the side surface 11b of the storage chamber 16.

On one side of the side frame 400 a protrusion 420 may be formed to protrude from the outer surface of the side frame 400, and the power receiver 800 may be disposed in the inside of the protrusion 420.

In the storage chamber 16 at least one power supply part 900 may be disposed to supply power to the power receiver 800 disposed on the shelf 30.

The power supply part 900 may wirelessly transmit power to the power receiver 800, and the power receiver 800 may wirelessly receive power from the power supply part 900.

For example, at least one power supply part 900 may be disposed on the side surface 11b of the inner case 11.

The power supply part 900 may be disposed only on one side of the storage chamber 16, which is adjacent and directed to where the power receiver 800 of the shelf 30 is disposed.

However, in the case where a plurality of shelves 30 are disposed at the same height, the power supply parts 900 may be disposed on the opposite sides of the storage chamber 16.

That is, the power supply part 900 provided on the left side wall of the storage chamber 16 may be coupled with the power receiver 800 of the shelf 30 on the left to supply power to the shelf 30 on the left, and the power supply part 900 provided on the right side wall of the storage chamber 16 may be coupled with the power receiver 800 of the shelf 30 on the right to supply power to the shelf 30 on the right.

A plurality of power supply parts 900 are provided, and the plurality of power supply parts 900 may be arranged in the up-down direction along the direction in which the shelf mounting member 20 extends.

That is, a plurality of power supply parts 900 may be arranged in the up-down direction to correspond to the heights at which the shelf 30 can be mounted.

Each power supply part 900 may be disposed to correspond to the mounting hole 21 of each shelf mounting member 20 and to be parallel to that mounting hole 21 in the left-right direction.

Thereby, even when a user removes the shelf 30 and then fastens the shelf 30 to a mounting hole 21 located at a different height to adjust the height of the shelf 30, the shelf 30 can be supplied with power by the power supply part 900 disposed parallel to the mounting hole 21 to which it is mounted.

Accordingly, while increasing the user's convenience resulting from the freedom of adjusting the height of the shelf 30, power can be stably supplied to the shelf 30 regardless of the height of the shelf 30.

Examples of a method by which the power supply part 900 and the power receiver 800 wirelessly transmit and receive power may include, but is not limited to, one of the inductive power method, the electromagnetic wave method, and the ultrasonic method.

The description of each power wireless transmission and reception method is as follows.

For example, the inductive power method may be a method in which a primary coil that receives energy from an external power source and forms a magnetic field is formed in the power supply part 900, and a secondary coil that generates an induced electromotive force due to the magnetic field is formed in the power receiver 800.

The electromagnetic wave method may be a method in which the power supply part 900 includes a magnetron receiving energy from an external power source and radiating electromagnetic waves, and the power receiver 800 includes an electromagnetic wave receiver converting the received electromagnetic waves into electrical energy.

The ultrasonic method may be a method in which the power supply part 900 includes an ultrasonic emitter receiving energy from an external power source and radiating ultrasonic waves, and the power receiver 800 includes an ultrasonic receiver converting the received ultrasonic waves into electrical energy.

In this specification, the power supply part 900 and the power receiver unit 800 to which the inductive power method is applied will be described as an example.

The power supply part 900 may be provided with a primary coil which forms a magnetic field, and the power receiver 800 may be provided with a secondary coil which generates an induced electromotive force.

Within the power supply part 900, the spiral primary coil may be provided in an oval shape extending long in the up-down direction, and a plurality of spiral primary coils may be provided and disposed in the up-down direction.

Additionally, within the power receiver unit 800, the spiral secondary coil may be provided in an oval shape extending long in the up-down direction, and a plurality of spiral secondary coils may be provided and disposed in the up-down direction.

The power receiver 800 receiving power wirelessly from the power supply part 900 as described above may be connected to the lighting device via a wire to transmit the power transmitted to the power receiver 800 to the lighting device.

The wire connecting between the power receiver 800 and the lighting device may be disposed within the side frame 400 to be connected to the lighting device through the side openings of the front frame 200 and the rear frame 300.

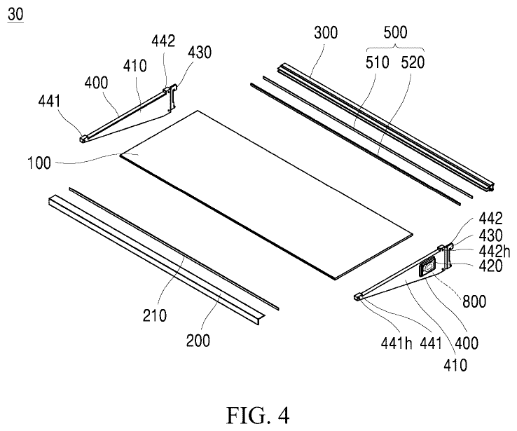

Hereinafter, the shelf 30 including the lighting device according to one embodiment of the present invention will be described in detail with reference to FIGS. 4 to 9.

The shelf 30 may include the plate 100 forming a surface on which articles of food are placed.

The plate 100 may be formed in an overall rectangular plate shape.

The plate 100 may diffuse light incident from the lighting device, which will be described later, to the top surface and the rear surface of the plate 100 to emit the light to the outside.

Thereby, the plate 100 can serve as a light guiding member that guides light by diffusing or scattering the light.

For this purpose, the plate 100 may be made of a transparent material which can transmit light.

For example, the plate 100 may use a transparent substance, and the transparent substance may be a transparent material including a translucent material, such as glass and a transparent injection molding product, and may be formed of a polymer material such as PMMA; however, the embodiments are not limited to this.

For example, the plate 100 may be formed of glass material.

Since the plate 100 is formed of glass material, it can have such a strength that it can stably support articles of food, and can also have high scratch resistance.

The outer surface of the plate 100 may undergo a surface treatment or have a light diffusion pattern formed thereon to effectively diffuse light.

For example, by performing surface treatment such as etching on the lower surface of the plate 100, it is possible to diffuse light effectively through the diffuse reflection on the lower surface of the plate 100.

Further, on the lower surface 100l of the plate 100 at least one pattern portion 110 having a predetermined pattern may be additionally formed.

For example, the pattern portion 110 may be, but is not limited to, an embossed pattern that protrudes downward from the lower surface 100l of the plate 100, or may be an engraved pattern that is caved or recessed upward from the lower surface 100l of the plate 100.

The pattern portion 110 will be described in more detail later.

In the rear side of the plate 100 the rear frame 300 may be disposed, which finishes the rear surface of the plate 100.

The rear frame 300 may be formed to have a length corresponding to the left and right width of the plate 100.

In this specification, the left-right direction refers to the direction extending between the opposite sides 11b of the storage chamber 16, and the front-rear direction refers to the direction extending between the rear side 11a of the storage chamber 16 and the door 13.

Additionally, the rear side of the plate 100 means a direction close to the rear surface 11a of the storage chamber 16, and the front side of the plate 100 means a direction close to the door 13.

The rear end of the plate 100 may be inserted and seated into the inside of the rear frame 300.

The rear frame 300 may be formed to extend in one direction with the opposite sides open.

The rear frame 300 may include a first receiving portion 331 into which a portion of the rear end of the plate 100 is inserted and seated, and a second receiving portion 332 disposed in the rear side of the first receiving portion 331, into which a first lighting device 500 is inserted and seated.

The first receiving portion 331 may have an up and down width corresponding to the thickness of the plate 100, and the second receiving portion 332 may have an up and down width corresponding to the thickness of the first lighting device 500.

The first receiving portion 331 may be formed to have an up and down width less than that of the second receiving portion.

In the front side of the first receiving portion 331 an opening 333 may be formed, into which the rear end of the plate 100 can be inserted.

The first receiving portion 331 and the second receiving portion 332 may be formed to extend in one direction with the opposite sides open.

In the second receiving portion 332 a combining part 334 may be formed, via which the rear frame 300 can be fastened with the side frame 400.

For example, at the lower portion of the second receiving portion 332 the connecting part 334 may be formed, which protrudes downward to be fastened with the side frame 400 by a separate fastening member such as a screw; however, the embodiments are not limited to this.

The rear frame 300 may include a metal material having high rigidity so as to stably support the weight of the plate 100.

For example, the rear frame 300 may include, but is not limited to, aluminum.

The first lighting device 500 may be slidably inserted into the second receiving portion 332 through one open side of the rear frame 300.

Thereby, the first lighting device 500 may be disposed between the rear surface 100b of the plate 100 and the rear surface of the rear frame 300.

Accordingly, the first lighting device 500 may also be formed to extend in one direction as long as the length corresponding to the left and right width of the rear frame 300.

The first lighting device 500 may include a first light-emitting member 510 and a first cover member 520.

The first light-emitting element 510 may include a substrate 511 and one or more light sources 512 arranged on the substrate 511.

For example, the light source 512 may be configured to irradiate light of various colors, but it is not limited thereto, and may also irradiate light of one color.

For example, the light source 512 may be, but is not limited to, an RGB LED (Red Green Blue light emitting diode) or a mini LED.

In this case, a plurality of light sources 512 may be arranged on the substrate 511 in one direction so as to be spaced apart from each other at a predetermined interval.

Thereby, the plurality of light sources 512 may be arranged in the left-right direction along the rear surface 100b of the plate 100.

Additionally, the light source 512 may be provided in the form of a surface light source rather than a point light source, and may be formed to extend in one direction along the substrate 511.

The first cover member 520 may protect the first light-emitting member 510 from external impact.

There is no particular restriction to the shape of the first cover member 520, and it may be a rod shape that finishes the entire surface of the first light-emitting member 510, or a storage shape that surrounds the first light-emitting member 510 to accommodate the first light-emitting member 510.

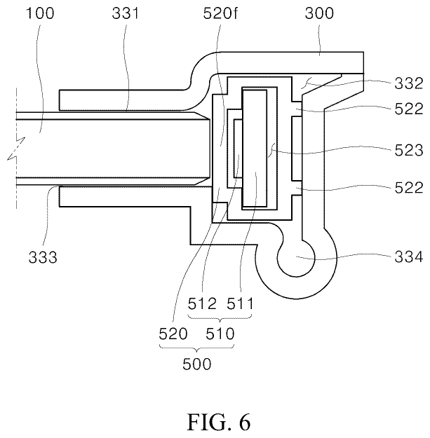

For example, referring to FIG. 6, the first cover member 520 may be formed to have a storage shape that surrounds the first light-emitting member 510.

In this case, the first cover member 520 may be formed to have a size as large as it can be accommodated in the second receiving portion 332.

The first cover member 520 may include a receiving portion 523 capable of storing the first light-emitting member 510 therein.

For example, the first cover member 520 may be formed in a form that surround the entire surface of the first light-emitting member 510 accommodated in the receiving portion 523, except for at least one side of the opposite sides thereof.

The first light-emitting member 510 may be inserted into the receiving portion 523 in a sliding manner through an open side of the first cover member 520 to be fixed thereto.

In this way, since the first cover member 520 is formed in a form that surrounds the first light-emitting member 510, the first light-emitting member 510 can be prevented from being brought into direct contact with the rear frame 300.

The first cover member 520 may be composed of an insulating material, so that it is possible to prevent the first light-emitting member 510 and the rear frame 300 from being short-circuited to each other, thereby improving the reliability of the first light-emitting member 510.

The first cover member 520 may be composed of a plastic material, such as, but not limited to, ABS (Acrylonitrile Butadiene Styrene) plastic.

The first cover member 520 may be translucent, and may function as a diffusion member which diffuses light emitted from the first light-emitting member 510.

The light sources 512 of the first light-emitting member 510 stored in the first cover member 520 may be disposed to face the rear surface 100b of the plate 100, so that the front surface 520f of the first cover member 520 can be positioned between the first light-emitting member 510 and the rear surface of the plate 100.

Thereby, the first light-emitting member 510, the front surface 520f of the first cover member 520, and the plate 100 may be positioned to overlap with each other in the front-rear direction.

In the case where a plurality of light sources 512 are disposed to be spaced apart from each other along the rear surface 100b of the plate 100, there may occur a spot phenomenon in which light is concentrated in a specific region according to the disposition positions of the light sources 512.

Thus, the disposition of the first cover member 520 between the light source 512 and the plate 100 enables it to function as a diffusion member diffusing the light from the light source 512, thereby reducing the occurrence of the spot phenomenon.

On the rear surface of the first cover member 520 at least one support member 522 may be formed, which protrudes toward the rear side of the rear frame 300.

In the case where the first light-emitting member 510 stored in the first cover member 520 generates heat over time, the thus generated heat may be transferred to the first cover member 520.

By forming the support member 522, as described above, which separates the rear surface of the first cover member 520 and the rear surface of the rear frame 300 by a predetermined distance, the contact surface area between the first cover member 520 and the rear frame 300 can be reduced, thereby reducing the transfer of the heat generated by the first light-emitting member 510 to the rear frame 300.

The first light-emitting member 510 may be disposed so that the light source 512 emitting light faces the rear surface 100b of the plate 100.

The first lighting device 500 disposed in this manner may emit light toward the rear surface 100b of the plate 100, thereby allowing the light to enter the inside of the plate 100, so that the plate 100 of the shelf 30 can emit light.

In this case, the first light-emitting member 510 may be disposed so as to overlap with at least a portion of the rear surface 100b of the plate 100, thereby allow the light emitted from the first light-emitting member 510 to be incident on the rear surface 100b of the plate 100 with minimal light loss.

Thus, the light source 512 of the first light-emitting member 510 and the rear surface 100b of the plate 100 may be disposed to overlap with each other in the front-rear direction.

In the front side of the plate 100 the front frame 200 may be disposed which finishes the front surface 100f of the plate 100.

Referring to FIG. 4, in the front frame 200 a reflective member 210 may be stored, which extends in the left-right direction along the front surface 100f of the plate 100 to be disposed on the front surface 100f of the plate 100.

The reflective member 210 can reflect the light emitted through the front surface 100f of the plate 100 back into the inside of the plate 100, thereby guiding the light to be emitted through the top surface 100t or the lower surface 100l of the plate 100 while further improving the lighting brightness of the shelf 30.

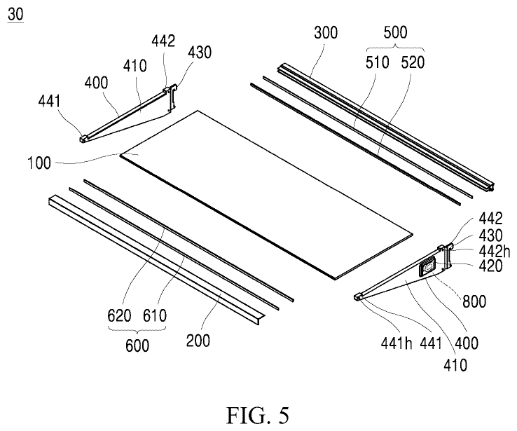

As another embodiment, referring to FIG. 5, in the front side of the plate 100 a second lighting device 600 may be disposed, which irradiates light to the front surface 100f of the plate 100.

Thereby, the first lighting device 500 may irradiate light on the rear surface 100b of the plate 100, and the second lighting device 600 may irradiate light on the front surface of the plate 100.

Consequently, the difference in light uniformity between the front surface 100f and the rear surface 100b of the plate 100 can be reduced, and the light uniformity on the entire top surface 100t of the plate 100 can be improved.

The second lighting device 600 may be formed to extend in one direction as long as a length corresponding to the left and right width of the front frame 200.

The second lighting device 600 may include a second light-emitting member 610 and a second cover member 620.

The second light-emitting member 610 may use the same kind of substrate 611 and light source 612 as the first light-emitting member 510.

The second cover member 620 may protect the second light-emitting member 610 from external impact.

There is no particular restriction to the shape of the second cover member 620, and it may have a rod shape that finishes the entire surface of the second light-emitting member 610, or a storage shape that surrounds the second light-emitting member 610 to store the second light-emitting member 610.

Meanwhile, some of the light incident on the rear surface 100b of the plate 100 may not be emitted through the top surface 100t or lower surface 100l of the plate 100, but be reflected on the top surface 100t and lower surface 100l.

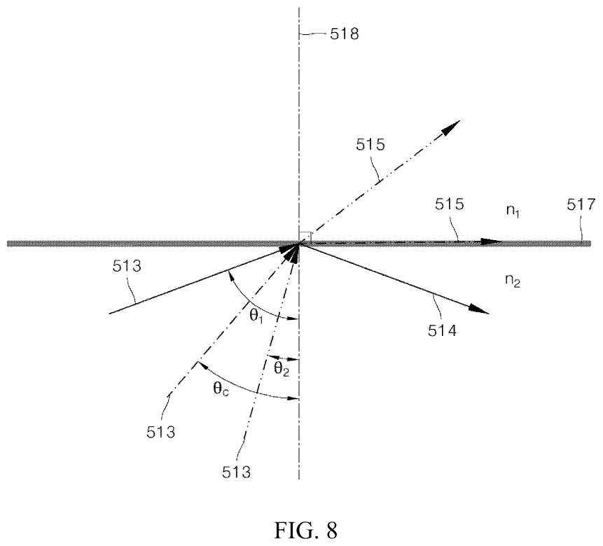

Referring to FIG. 8, the reflected light and refracted light generated at the interface 517 between the plate 100 and the air will be described.

The first refractive index n₁ of air may be defined as 1, and the second refractive index n₂ of the plate 100 composed of glass may be defined as 1.5.

Thus, the second refractive index n₂ is set higher than the first refractive index n₁.

When light travels from a medium with a high refractive index to a medium with a low refractive index, light incident at an angle greater than the critical angle θ_{C} may be totally reflected.

When incident light 513 is refracted at the interface 517, the incident angle that makes the refracted light 515 have a refraction angle of 90 degrees is defined as the critical angle θ_{C}.

In this case, the refraction angle of the refracted light 515 may be measured as the angle formed by the interface 517 and the normal line 518 of the interface 517.

If the incident light 513 is incident at a first incident angle θ₁ greater than the critical angle θ_{C}, the incident light 513 is not emitted to the outside of the interface 517, but is reflected and progresses as reflected light 514, while if the incident light 513 is incident at a second incident angle θ₂ less than the critical angle θ_{C}, the incident light 513 is refracted at the interface 517 and can progress as refracted light 515 emitted to the outside of the interface 517.

Through this measurement, the critical angle θ_{C} may be measured as approximately 42 degrees according to Snell's law based on the interface 517 between the plate 100 composed of glass and the air.

In the case of incident lights 513 incident at an incident angle greater than approximately 42 degrees, they cannot be emitted through the top surface 100t or lower surface 100l of the plate 100, but can be totally reflected within the plate 100 and emitted through the front surface 100f of the plate 100.

In view of the above, an embodiment according to the present invention may provide one or more pattern portions 110 formed on the lower surface 100l of the plate 100 so that diffuse reflection rather than total reflection can occur as much as possible on the lower surface 100l.

The pattern portion 110 may be composed of a material having a refractive index different from that of the plate 100.

The refractive index of the pattern portion 110 may have a refractive index between the refractive index of the plate 100 and the refractive index of air.

For example, the pattern portion 110 may be composed of an inorganic material, but there is no particular restriction thereto.

The pattern portion 110 can change the interface formed by the plate 100 and air into the interface formed by the plate 100 and the pattern portion 110 so that the conditions for total reflection to occur on the lower surface 100l of the plate 100 can be changed to those for diffuse reflection to occur thereon.

Accordingly, incident lights 513 that would otherwise be totally reflected on the lower surface 100l of the plate 100 can be changed into emission light 516 emitted through the top surface 100t of the plate 100 as most of them undergo diffuse reflection on the pattern portion 110.

Thereby, the ratio of the reflected light 514 totally reflected within the plate 100 can be reduced, and thus the ratio of the emission light 516 emitted through the front surface 100f of the plate 100 can also be reduced.

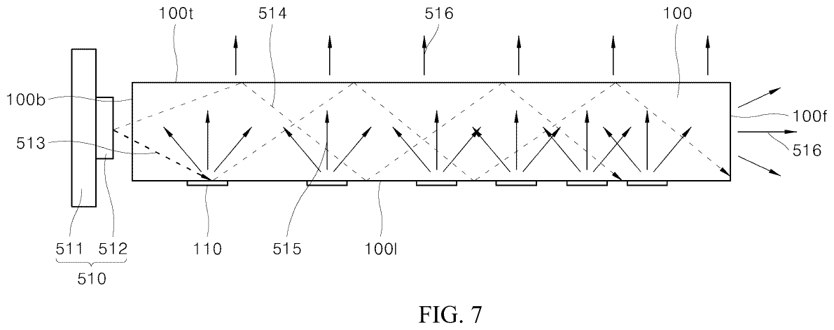

Referring to FIG. 7, the pattern portion 110 may be an embossed pattern.

In this case, the embossed pattern may have one of various shapes, such as a prism shape, a hemispherical shape, and a plate shape, but there is no particular restriction thereto.

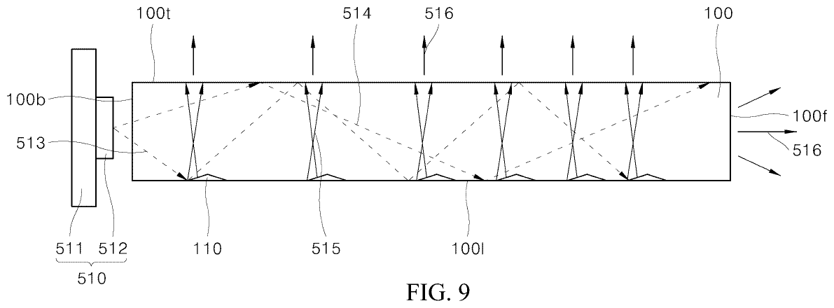

Alternatively, referring to FIG. 9, the pattern portion 110 may be an engraved pattern.

In this case, the negative pattern may have one of various shapes, such as a prism shape, a hemispherical shape, and a plate shape, but there is no particular restriction thereto.

For example, the pattern portion 110 may be formed using a glass printing method; however, the embodiments are not limited to this.

The glass printing is a method of printing a pattern, such as an image, on the surface of glass, in which, by way of example, an image is coated on glass by applying glass ink thereon, and then the glass is heated to 600 to 700 degrees, enabling the ink to seep into the glass while strengthening the glass.

However, the glass printing method is not limited to this, but, for example, the glass printing method may utilize one of various methods, such as a silk screen printing method, a digital printing method, a sandblasting method, an etching method, and a glass painting method.

Alternatively, the pattern portion 110 may be implemented by a taping method using an attachment member with an adhesive force.

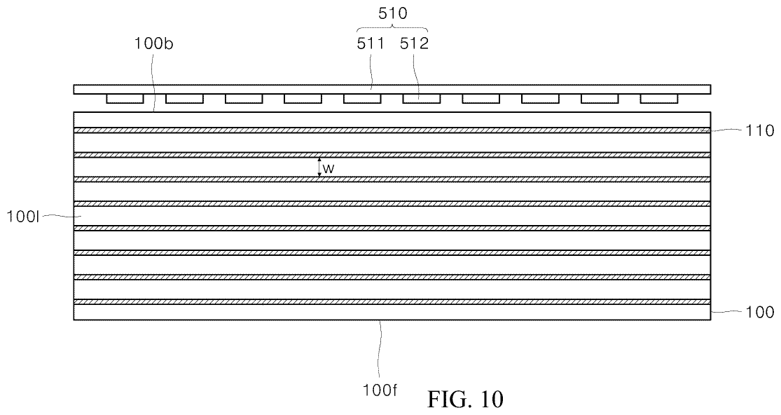

Hereinafter, with further reference to FIGS. 10 to 14, the various disposition forms of the pattern portions 110 will be discussed in more detail.

Referring to FIG. 10, on the lower surface 100l of the plate 100 a plurality of pattern portions 110 may be disposed, which are arranged to have predetermined intervals w.

The plurality of pattern portions 110 may be arranged to be spaced apart from each other in the front-rear direction of the plate 100.

In this case, the intervals w between pattern portions 110 adjacent to each other may be constant.

Each pattern portion 110 may extend along the left-right direction of the plate 100.

That is, each pattern portion 110 may extend in the same direction as the direction in which the first light-emitting member 510 extends.

Thereby, the lights emitted from a plurality of light sources 512 arranged along the left-right direction of the plate 100 can be reflected as irregularly as possible by the pattern portion 110.

As an example, each pattern portion 110 may be a linear pattern extending in the left-right direction of the plate 100; however, the embodiments are not limited to this.

Additionally, each pattern portion 110 may extend continuously along the left-right direction of the plate 100.

Thereby, the incident light of the light source 512 incident at a direction orthogonal to the direction in which the pattern portion 110 extends can be reflected as much as possible in the pattern portion 110.

However, the embodiments are not limited to this, and each pattern portion 110 may extend discontinuously along the left-right direction of the plate 100.

That is, the plurality of pattern portions 110 may be arranged to be spaced apart from each other by a predetermined interval in the left-right direction of the plate 100 as well as in the front-rear direction thereof.

In this case, each pattern portion 110 may be disposed at a position where it overlaps with the light source 512 of the first light-emitting member 510 in the front-rear direction.

Thereby, the incident light of the light source 512 incident at a direction orthogonal to the direction in which the pattern portion 110 extends can be reflected as much as possible in the pattern portion 110.

Further, the opposite side ends of the pattern portion 110 may respectively protrude further outwards than the outer ends of the light sources 512 among the plurality of light sources 512 arranged in the first light-emitting member 510, which are disposed at the opposite outermost locations.

As described above, the pattern portion 110 may be formed to extend further outwards than the light sources 512, and so it is possible to guide the occurrence of diffuse reflection by the pattern portion 110 even in regions adjacent to the opposite side surfaces of the plate 100, thereby reducing the occurrence of dark regions in the opposite sides of the plate 100.

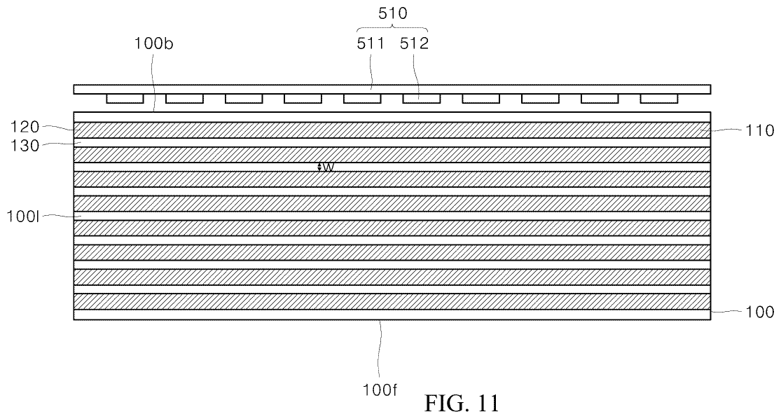

Referring to FIG. 11, the width in the front-rear direction of each pattern portion 110 may be formed greater than the width in the front-rear direction of the pattern portion 110 illustrated in FIG. 10.

As the width in the front-rear direction of the pattern portion 110 is increased in this way, the ratio of light irregularly reflected by the lower surface 100l of the plate 100 can be further increased.

Further, the surface area of a pattern region 120 on the lower surface 100l of the plate 100, in which the pattern portion 110 is formed, may be greater than the surface area of the non-pattern region 130 in which no pattern portion 110 is formed.

Consequently, it is possible to further increase the ratio of light reflected irregularly on the pattern region 120 formed on the lower surface 100l of the plate 100.

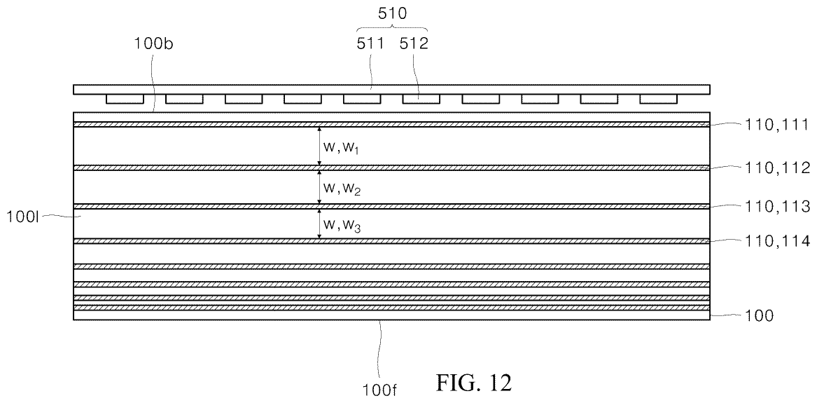

Referring to FIG. 12, the intervals w between the pattern portions 110 arranged in the front-rear direction on the lower surface 100l of the plate 100 may be set differently.

In the case where the first light-emitting member 510 is disposed on the rear surface 100b of the plate 100 without any separate light-emitting member being disposed on the front surface 100f of the plate 100, the amount of light emitted from a region adjacent to the front surface 100f of the plate 100, in which no light-emitting member is disposed, may be reduced.

In view of the above, in the case where the light-emitting member is disposed on only one side of the plate 100, by setting the intervals w between the pattern portions 110 differently, the light amount in a region far from the light-emitting member can be adjusted.

As an example, the intervals between the plurality of pattern portions 110 arranged in the front-rear direction of the plate 100 may become decreased as they become farther from the first lighting device 500, that is, the first light-emitting member 510.

For example, the pattern portions 110 may be defined as the first pattern portion 111, the second pattern portion 112, the third pattern portion 113, and the fourth pattern portion 114 in order from the closest to the first light-emitting member 510 to the furthest therefrom.

And the interval between the first pattern portion 111 and the second pattern portion 112 may be defined as the first interval w1; the interval between the second pattern portion 112 and the third pattern portion 113 may be defined as the second interval w2; and the interval between the third pattern portion 113 and the fourth pattern portion 114 may be defined as the third interval w3.

In this case, the second interval w2 may be set to be smaller than the first interval w1, and the third interval w3 may be set to be smaller than the second interval w2.

That is, as it becomes farther from the first light-emitting member 510, the interval between pattern portions 110 adjacent to each other may become denser.

As described above, because the interval between pattern portions 110 adjacent to each other is decreased as it becomes farther from the first lighting device 500, it is possible not only to reduce the dark region even in the top surface 100t of the plate 100, which is far from the first lighting device 500, but also to implement the shelf lighting with improved light uniformity across the entire region.

Further, the intervals between the plurality of pattern portions 110 may be decreased by the same width from the previous one.

For example, the difference between the first interval w1 and the second interval w2 may be equal to the difference between the second interval w2 and the third interval w3, and similarly, the same rule may be applied to the pattern portions 110 disposed thereafter.

As described above, because the intervals between the plurality of pattern portions 110 are reduced by the same width in this way, the light amount emitted through the top surface 100t of the plate 100 can be more uniformly adjusted, thereby implementing the shelf lighting with improved light uniformity across the entire region.

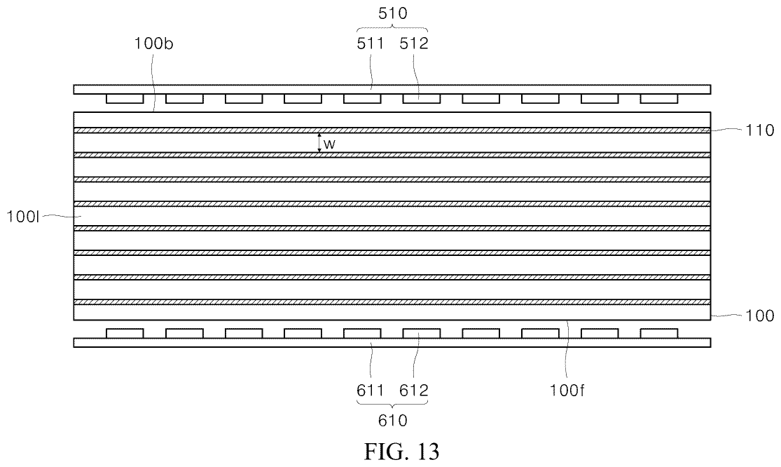

Referring to FIG. 13, the first light-emitting member 510 of the first lighting device 500 may be disposed on the rear surface 100b of the plate 100, and the second light-emitting member 610 of the second lighting device 600 may be disposed on the front surface 100f of the plate 100.

That is, the first lighting device 500 and the second lighting device 600 may be positioned to face each other and irradiate light with the plate 100 interposed therebetween.

In this way, by disposing the separate lighting devices on the front surface 100f and the rear surface 100b of the plate 100, respectively to irradiate light, the amounts of light emitted through the region adjacent to the front surface 100f of the plate 100 and the region adjacent to the rear surface 100b thereof can be adjusted as uniformly as possible.

In this case, the intervals w between the pattern portions 110 arranged in the front-rear direction of the plate 100 may be identical to each other.

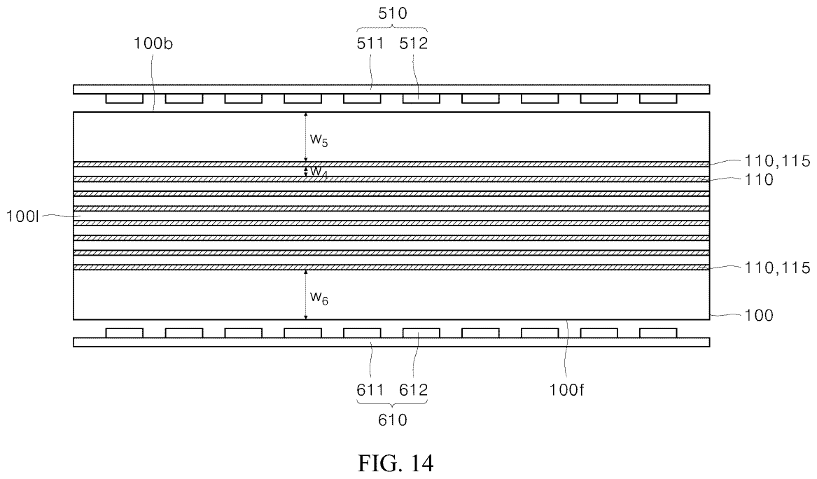

Referring to FIG. 14, the first light-emitting member 510 of the first lighting device 500 may be disposed on the rear surface 100b of the plate 100, and the second light-emitting member 610 of the second lighting device 600 may be disposed on the front surface 100f of the plate 100.

In this case, the interval between the front surface 100f of the plate 100 or the rear surface 100b of the plate 100 and the outermost pattern portion 115 may be greater than the interval between the pattern portions 110 adjacent to each other.

For example, the interval between the front surface 100f of the plate 100 and the outermost pattern portion 115 closest to the front surface 100f of the plate 100 may be defined as the sixth interval w6; the interval between the rear surface 100b of the plate 100 and the outermost pattern portion 115 closest to the rear surface 100b of the plate 100 may be defined as the fifth interval w5; and the interval between the pattern portions 110 adjacent to each other may be defined as the fourth interval w4.

In this case, the fifth interval w5 and the sixth interval w6 may be set greater than the fourth interval w4.

Additionally, the fifth interval w5 and the sixth interval w6 may be set identical to each other.

As described above, by making denser the intervals between the pattern portions 110 spaced far from the light-emitting member and close to the center region of the plate 100, the amount of light emitted through the center region of the plate 100 spaced far from the light-emitting member can be adjusted as uniformly as possible.

Although the present invention has been described with reference to the illustrative drawings as the above, the present invention is not limited to the embodiments and drawings disclosed in this specification, and it is obvious that various modifications can be made by those skilled in the art without departing from the scope of the technical idea of the present invention. Additionally, even if the effects related to the configuration of the present invention were not explicitly described while explaining the embodiments of the present invention, it is obvious that the effects predictable from the configuration should also be acknowledged.

What is claimed is:

1. A refrigerator comprising:
a cabinet comprising at least one storage chamber; and
at least one shelf disposed within the storage chamber,
wherein the shelf includes:
a plate; and
a first lighting device disposed at a rear side of the plate and irradiating light to a rear surface of the plate, and
wherein a plurality of pattern portions are disposed on a lower surface of the plate at predetermined intervals.

2. The refrigerator of claim 1, wherein the plate and the pattern portions are composed of materials having different refractive indices.

3. The refrigerator of claim 1, wherein the plate is composed of glass material.

4. The refrigerator of claim 1, wherein the pattern portions are an embossed pattern protruding downward from the lower surface of the plate.

5. The refrigerator of claim 1, wherein the pattern portions are an engraved pattern recessed into the lower surface of the plate.

6. The refrigerator of claim 1, wherein the plurality of pattern portions are arranged in a front-rear direction of the plate, and
wherein the intervals between the plurality of pattern portions are constant.

7. The refrigerator of claim 1, wherein the plurality of pattern portions are arranged in a front-rear direction of the plate, and
wherein the intervals between the plurality of pattern portions are different from each other.

8. The refrigerator of claim 1, wherein the plurality of pattern portions are arranged in a front-rear direction of the plate, and
wherein the intervals between the plurality of pattern portions decrease with increasing distance from the first lighting device.

9. The refrigerator of claim 8, wherein the intervals between the plurality of pattern portions decrease by a constant amount relative to the adjacent preceding interval.

10. The refrigerator of claim 1, wherein the pattern portions are a linear pattern extending along a left-right direction of the plate.

11. The refrigerator of claim 10, wherein the pattern portions extend continuously along the left-right direction of the plate.

12. The refrigerator of claim 10, wherein the first lighting device comprises a first light-emitting member including one or more light sources disposed along the rear surface of the plate, and wherein opposite side ends of the pattern portions protrude further outwards than outer ends of the outermost light sources, respectively.

13. The refrigerator of claim 1, wherein the shelf further includes a reflective member extending along and disposed on the front surface of the plate.

14. The refrigerator of claim 1, wherein the first lighting device includes:
a first light-emitting member including a substrate extending in one direction and one or more light sources disposed on the substrate; and
a first cover member storing the first light-emitting member, and
wherein the first cover member surrounds an entire surface of the first light-emitting member except at least one of its opposite sides.

15. The refrigerator of claim 14, wherein the shelf further includes a rear frame storing the first cover member and finishing the rear surface of the plate, and
wherein the first cover member is composed of an insulating material, and the rear frame includes a metal material.

16. The refrigerator of claim 14, wherein the first cover member is a diffusion member diffusing light emitted from the first light-emitting member.

17. The refrigerator of claim 14, wherein a front surface of the first cover member is positioned between the first light-emitting member and the rear surface of the plate, and
wherein the first light-emitting member, the front surface of the first cover member, and the plate are positioned to overlap with each other in a front-rear direction.

18. The refrigerator of claim 1, wherein the shelf further includes a second lighting device disposed at a front side of the plate and irradiating light to a front surface of the plate,
wherein the plurality of pattern portions are arranged in a front-rear direction of the plate, and
wherein the intervals between the plurality of pattern portions are constant.

19. The refrigerator of claim 18, wherein an interval between the front surface of the plate or the rear surface of the plate and an outermost pattern portion is greater than an interval between pattern portions adjacent to each other.

20. The refrigerator of claim 1, wherein a surface area of a pattern region on the lower surface of the plate, in which the pattern portions are disposed, is greater than a surface area of a non-pattern region on the lower surface of the plate, in which no pattern portion is disposed.
